(19) United States
(12) Patent Application Publication
(10) Pub. No.: US 2022/0324571 A1
(43) Pub. Date: Oct. 13, 2022

(54) Payload Delivery Mechanism Suitable for Use With a Drone

(71) Applicant: Jacques Venter, Rivonia (ZA)

(72) Inventor: Jacques Venter, Rivonia (ZA)

(21) Appl. No.: 17/620,162

(22) PCT Filed: Jun. 10, 2020
(86) PCT No.: PCT/IB2020/055462

§ 371 Date: Dec. 17, 2021

(30) Foreign Application Priority Data
Jun. 19, 2019 (ZA) 2019/03959

(51) Int. Cl. B64D 1/12; B64C 39/02

(52) U.S. Cl. CPC B64D 1/12; B64C 39/024; B64C 2201/128

(57) ABSTRACT

This invention relates to a payload delivery mechanism suitable for use with a drone. The mechanism includes a load carrying and release mechanism which is displaceable between a retaining position, in which at least part of the payload is retained by the load carrying and release mechanism, and a release position, in which the at least part of the payload is releasable from the load carrying and release mechanism. The mechanism has a first release mode in which the load carrying and release mechanism is displaced from the retaining position to the release position by an actuator that is in use electrically actuated, and a second release mode in which the load carrying and release mechanism is displaced, against the bias exerted by the biasing element, from the retaining position to the release position when a predetermined maximum external load is exerted on the load carrying and release mechanism.

### CROSS-REFERENCE TO RELATED APPLICATIONS

This application is the United States national phase of International Application No. PCT/IB2020/055462 filed Jun. 10, 2020, and claims priority to South African Patent Application No. 2019/03959 filed Jun. 19, 2019, the disclosures of which are hereby incorporated by reference in their entirety.

### BACKGROUND TO THE INVENTION

### Field of the Invention

This invention relates to a payload delivery mechanism suitable for use with a drone and more particularly, but not exclusively, to a payload delivery mechanism suitable for delivering fishing bait or a fishing line to a desired location.

### Description of Related Art

A drone is an unmanned aerial vehicle that is controlled by a remote human operator. Many different drones are available in the trade, and are used for a variety of purposes including, to name but a few, military, cinematographic and recreational uses.

In recent times, and in particular since the advent of consumer drones, there have been numerous efforts at modifying drones for use as payload delivery systems. In one specific example, people have tried to modify drones so that they can be used as fishing line casting systems. The intention is to provide a device through which a fishing line can be delivered to areas where the lines cannot traditionally be cast. Line casting boats have been used in the past, but the reach of these boats are limited, and it is also difficult to cast a line consistently in the same area. In addition, the travelling speed of these boats is also relatively slow.

It would therefore make sense to utilise the benefits of a drone (reaching distance, speed, maneuverability, repeatability) for the purposes of delivering fishing lines at a required location. However, conventional drones are not equipped to give effect to this required functionality. In particular, the drones that are commercially available to the ordinary consumer do not include a payload delivery mechanism. To this end, many retrofit solutions have been proposed where a release mechanism is secured to a body of the drone, which release mechanism is then remotely actuated.

Some of the retrofit payload delivery devices include a load carrying and release mechanism for releasably carrying the load while the drone is on its way to a desired location. The load carrying and release mechanism is actuated by an actuating mechanism, for example in the form of a servo motor (or other suitable actuator). The servo motor typically actuates a push/pull rod that is connected to a drive shaft of the servo motor. The push/pull rod is therefore displaceable between a first position in which it is configured to carry a load, and a second position in which it is configured to release a load. This type of selectively actuated load carrying and release mechanism generally works well, but is known to fail at times if, for example, the servo motor fails, or the push rod gets stuck. Also, this type of mechanism is not capable of releasing the fishing line under emergency conditions, for example should the reel of the fishing rod lock up.

Release mechanisms have been proposed that releases a fishing line under the emergency conditions mentioned above (i.e. when a predetermined tension is exerted on the fishing line, and hence the release mechanism), but such mechanisms are not desirable for use under normal release conditions due to the plucking or snapping action of such a release (for example, when the fishing lines overcomes an internal bias of the release mechanism). The impact forces exerted on the drone when using this type of delivery mechanism as a normal release mechanism is not ideal, and can potentially damage the drone—in particular if this happens regularly. Also, such release mechanisms will only work in the fishing environment, and not in other application where controlled release is required.

It is accordingly an object of the invention to provide a payload delivery mechanism suitable for use with a drone that will, at least partially, alleviate the above disadvantages.

It is also an object of the invention to provide a payload delivery mechanism suitable for use with a drone which will be a useful alternative to existing payload delivery mechanisms.

It is a further object of the invention to provide a release mechanism for a payload delivery device mechanism suitable for use with a drone that will, at least partially, alleviate the above disadvantages.

### SUMMARY OF THE INVENTION

According to the invention there is provided a payload delivery mechanism suitable for use with a drone, the payload delivery mechanism including:
a load carrying and release mechanism which is displaceable between a retaining position, in which at least part of the payload is retained by the load carrying and release mechanism, and a release position, in which the at least part of the payload is releasable from the load carrying and release mechanism;
an actuator for displacing the load carrying and release mechanism from the retaining position to the release position; and
a biasing element for biasing the load carrying and release mechanism towards the retaining position;
characterized in that the load carrying and release mechanism have two release modes,
wherein, in the first release mode, the load carrying and release mechanism is displaced from the retaining position to the release position by the actuator that is in use electrically actuated; and
wherein, in the second release mode, the load carrying and release mechanism is displaced, against the bias exerted by the biasing element, from the retaining position to the release position when a predetermined maximum external load is exerted on the load carrying and release mechanism.

There is provided for the payload delivery mechanism to include two adjacent release elements that are displaceable between the retaining position in which the two release elements abut one another, and the release position in which the two release elements are at least partially spaced apart.

The payload delivery mechanism is further characterized in that the actuator acts on a first release element, and in that a second release element is displaceable away from the first release element, and biased towards the first release element.

The biasing element used to bias the second element towards the retaining position may be in the form of a spring.

There is provided for the degree of compression of the spring to be adjustable, in order for a release force of the load carrying and release mechanism to be adjustable.

An adjustment knob, suitable for actuating a spring compression adjustment configuration, may be provided on the housing.

The release elements may be configured to at least partially oppose one another.

There is provided for at least one of the elements to be an at least partially rounded, curved, or slanted clamping element.

There is provided for both the elements to be at least partially rounded, curved or slanted clamping elements.

In one embodiment there is provided for the elements to be at least partially rounded elements.

There is provided for rounded surfaces of the two at least partially rounded clamping elements to abut when in the retaining position, and to be at least partially spaced apart when in the release position.

There is provided for a nip to be formed at the interface of the two rounded surfaces.

There is provided for the rounded surfaces to be at least partially spherical.

Preferably, the at least partially rounded elements are in the form of at least partially spherical elements.

There is provided for the at least partially spherical elements to be in the form of spheres, but there is also provided for other arrangements to suffice, for example an elongate cylinder that terminates in a spherical or at least partially spherical end face.

The actuator may be an electrical, mechanical or electro mechanical actuator.

There is provided for the actuator to include a servo motor that displaces the first element between the retaining and release positions.

The servo motor may drive an elongate push rod, which may in turn displace the first element.

An offset cam may be located on a drive shaft of the servo motor for displacing the push rod when the servo motor is actuated.

There is also provided for the payload delivery mechanism to including a housing, wherein the load carrying and release mechanism is located inside the housing.

The housing may be releasably securable to the drone.

The housing may be integrally formed with the drone.

### BRIEF DESCRIPTION OF THE DRAWINGS

A preferred embodiment of the invention is described by way of a non-limiting example, and with reference to the accompanying drawings in which:

FIG. 1 is a side view of a first embodiment of the payload delivery mechanism in accordance with the invention;

FIG. 2 is top plan view of the payload delivery device of FIG. 1;

FIG. 3 is a cross-sectional side view of the payload delivery device of FIG. 1;

FIG. 4 is an enlarged view of the mechanical actuator of the payload delivery device of FIG. 3; and

FIG. 5 is an enlarged view of the release mechanism of the payload delivery device of FIG. 3.

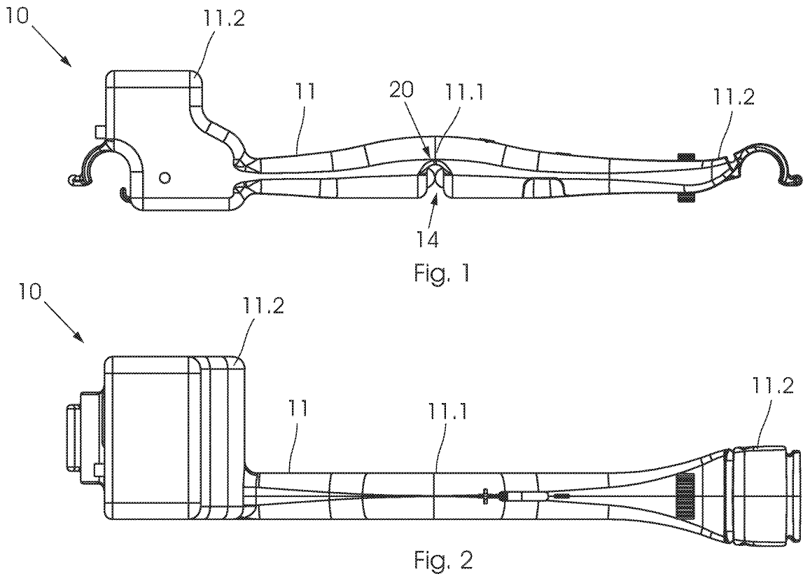

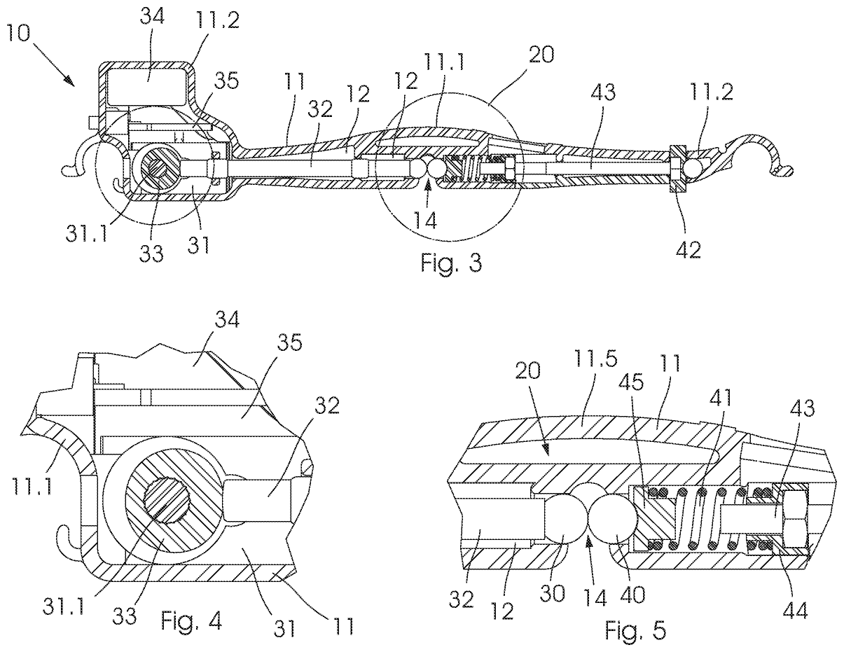

### DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Referring to the drawings, in which like numerals indicate like features, a non-limiting example of payload delivery mechanism suitable for use with a drone in accordance with the invention is generally indicated by reference numeral 10.

Referring now to the figures, the payload delivery mechanism 10 of the illustrated embodiment comprises a housing 11 which is securable to leg formations (not shown) of the drone. The housing 11 includes a proximal zone 11.1, and two distal zones 11.2. The distal zones 11.2 are in use secured to the drone, while the proximal zone 11.1 houses the load carrying and release mechanism 20. It should be noted that the housing may also be integrally formed with the drone, and does not have to be a discrete component.

A receiving pocket 14 is formed in the proximal zone 11.1 of the housing 11, and a part of a load carrying and release mechanism 20 (as is described in more detail below) extends into the receiving pocket. The edges of the pocket are rounded to ensure that an elongate element located inside the pocket cannot catch on a sharp corner of the pocket.

In this embodiment, the distal end zones 11.2 of the housing 11 are configured to act as securing formations for securing the housing 11 to the drone. These may take many different forms, and do not form part of the gist of the invention. As mentioned above, the housing can just as well form part of the body of the drone (not shown).

In this embodiment, a load carrying and release mechanism 20 is located in the proximal zone 11.1 of the housing 11, and includes two at least partially rounded elements that are located adjacent one another, and rounded surfaces of which extend at least partially into the receiving pocket 14 of the housing 11. There is provided for the rounded surfaces to be at least partially spherical, and for the at least partially rounded elements to be in the form of at least partially spherical elements. In this embodiment, the at least partially spherical elements are in the form of spheres, but there is also provided for other arrangements to suffice, for example an elongate cylinder that terminates in a spherical or at least partially spherical end face. Also, it may for example also be possible to have one rounded element (for example the biased element) and one element that is not rounded (for example, the remotely actuated element may be in the form of a pin). The so-called rounded element may also not be rounded as such, but may for example have a slanted or tapered surface. There is provided for the elements to be longitudinally opposed to one another (as shown in the example, where their axis of movement will be substantially in the same line), but the elements may also be offset (wherein their axis of movement are not in the same line, e.g. 90 degrees offset). The important part is for the elements to be adjacent one another, and to abut when the mechanism is in a retaining position.

The two elements, in this embodiment spheres (30 and 40), are located adjacent one another, and are displaceable between a retaining position, in which the two spheres (30 and 40) abut, and a release position in which the two spheres (30 and 40) are at least partially spaced apart. In use, the spheres will trap a fishing line or a linkage coupled to a fishing line inside the pocket 14 when the spheres are in a secure position.

The first sphere 30 is displaced between the retaining and release positions by way of a remotely actuatable actuating mechanism. In this embodiment the actuating mechanism is an electro mechanical actuating mechanism that includes a servo motor 31 located in a distal zone 11.2 of the housing 11. The servo motor 31 is powered by a battery 34, and controlled by control means on a PC board 35. The servo motor is actuated remotely. An offset cam 33 is located on a drive shaft 31.1 of the servo motor 31. A push rod 32, which is slideably located in a channel 12 provided in the housing 11, is displaceable by the cam towards the first sphere 30 when the servo motor is actuated (as shown in FIG. 4). When the servo motor is deactivated (or returned to its original state) the cam will rotate through 180 degrees from the position shown in FIG. 4, so as to allow the push rod 32 to be displaced away from the first sphere 30. In some embodiments the push rod may be biased towards the cam 33, but in a preferred embodiment there will be no biasing element, and the first sphere 30 will simply push the push rod towards the cam 33 when a load is exerted on the first sphere 30 when the actuating mechanism is in the release position.

In the embodiment shown in the drawings, the total travel of the push rod 32, and hence the first sphere 30, will be about 1.5 mm.

The second sphere 40 is biased towards the secure position by way of at least one biasing element, in this case a spring 41 that exerts a force onto the sphere 40. The compression of the spring 41, and hence the force exerted thereby, is adjustable in order for the closing force (or inversely described, the release force) of the sphere 40 to be adjustable. A control knob 42 is provided on the housing 11, and may for example rotate a threaded element 43 that is in turn rotated in order to adjust the position of a plunger 44 of the spring 41. The plunger 44 acts on an operatively outer end of the spring in order to reduce or increase the spring compression. An operatively inner end of the spring acts on a profiled spigot 45, which in turn abuts the second sphere 40. In use, as small gap (in this case about 0.5 mm) is left between the spigot 45 and the end of the housing, meaning that the second sphere 40 will be displaced about 0.5 mm towards the first sphere 30 when the first sphere is displaced to a release position. The gap between the two spheres will therefore be about 1 mm during normal release.

In use, a part of the payload (such as a fishing line or a linkage extending from a fishing line—in this specification the payload carrying mechanism is interpreted to be part of the payload) will be secured relative to the housing by moving the spheres apart, so as to result in the linkage being trapped in the pocket 14. This can be achieved by simply forcing the second sphere 40 against its bias towards a release position, but can also be done by actuating the actuating mechanism so as to displace the first sphere 30 towards the release position. The drone can now be flown to a desired location. When the desired location is reached, the actuating mechanism is actuated, resulting in the push rod 32 being displaced away from the first sphere 30. The weight of the load, in combination with the rounded surface of the sphere, will result in the fishing line or elongate element trapped in the pocket exerting a sideways force onto the first sphere 30. The first sphere 30 will accordingly be displaced in the direction of the retracted push rod 32, and the fishing line or elongate element will be released. This is the release action that will be followed during normal operation, an in this specification is referred to as the first release mode.

Should the actuating mechanism fail, or should the fishing line suddenly stop moving due to locking of the reel or any other cause, the emergency release action, or the second release mode, will kick in. In this situation, the first sphere 30 will remain stationary. The drone will continue to move forward, and the payload (through the fishing line) will effectively start pulling on the drone, and more particularly on the load carrying and release mechanism 20. The fishing line, at this point located in the nip formed between the two spheres, will exert a sideways force on the rounded surface of the second sphere 40. Once this pulling force exceeds the release force of the second sphere 40, the sphere will be displaced (by the fishing line or linkage) to the release position, and the fishing line will escape under gravity. When reference is made to an external load being exerted on the payload carrying mechanism, it relates to the load exerted by the payload (though the fishing line or linkage) onto the load carrying and release mechanism, i.e. in this example the two spheres.

The corners and edges of the pocket 14 are rounded so as to prevent the fishing line or linkage from catching on the housing. Depending on the requirements, the knob 42 can be adjusted in order to adjust the emergency release limit of the drone by adjusting the release force of the load carrying and release mechanism 20.

It will be appreciated that the above is only one embodiment of the invention and that there may be many variations without departing from the spirit and/or the scope of the invention.

1. A payload delivery mechanism suitable for use with a drone, the payload delivery mechanism comprising:
a load carrying and release mechanism which is displaceable between a retaining position, in which at least part of the payload is retained by the load carrying and release mechanism, and a release position, in which the at least part of the payload is releasable from the load carrying and release mechanism;
an actuator for displacing the load carrying and release mechanism from the retaining position to the release position; and
a biasing element for biasing the load carrying and release mechanism towards the retaining position;
the load carrying and release mechanism comprising a first release mode and a second release mode,
wherein, in the first release mode, the load carrying and release mechanism is displaced from the retaining position to the release position by the actuator that is in use electrically actuated; and
wherein, in the second release mode, the load carrying and release mechanism is displaced, against the bias exerted by the biasing element, from the retaining position to the release position when a predetermined maximum external load is exerted on the load carrying and release mechanism.

2. The payload delivery mechanism of claim 1, wherein the two adjacent release elements are located adjacent one another when in the retaining position, and wherein the two release elements are spaced apart when in the release position.

3. The payload delivery mechanism of claim 1, wherein the actuator acts on a first release element, and wherein a second release element is displaceable away from the first release element, and is biased towards the first release element.

4. The payload delivery mechanism of claim 3, wherein the second release element is biased towards the first release element by way of the biasing element.

5. The payload delivery mechanism of claim 1, wherein the biasing element used to bias the second element towards the retaining position is in the form of a spring.

6. The payload delivery mechanism of claim 5, wherein the degree of compression of the spring is adjustable, in order for a release force of the load carrying and release mechanism to be adjustable.

7. (canceled)

8. (canceled)

9. The payload delivery mechanism of claim 2, wherein the release elements are configured to at least partially oppose one another.

10. The payload delivery mechanism of claim 2, wherein at least one of the s elements is an at least partially rounded, curved, or slanted clamping element.

11. (canceled)

12. (canceled)

13. (canceled)

14. The payload delivery mechanism of claim 1, wherein the actuator is an electrical, mechanical or electro mechanical actuator.

15. The payload delivery mechanism of claim 14, wherein the actuator comprises a servo motor that displaces the first element between the retaining and release positions.

16. The payload delivery mechanism of claim 15, wherein the servo motor drives an elongate push rod, which may in turn displace the first element, and wherein an offset cam is located on a drive shaft of the servo motor for displacing the push rod when the servo motor is actuated.

17. The payload delivery mechanism of claim 1, comprising a housing, wherein the load carrying and release mechanism is located inside the housing.

18. The payload delivery mechanism of claim 17, wherein the housing is releasable securable to the drone.

19. The payload delivery mechanism of claim 17, wherein the housing is integrally formed with the drone.

20. A drone comprising a payload delivery mechanism of claim 1.

21. The payload delivery mechanism of claim 1, wherein the load carrying and release mechanism comprises two adjacent release elements that are displaceable between the retaining position and the release position, and wherein the two adjacent release elements are displaceable substantially in the same plane.

22. The payload delivery mechanism of claim 2, wherein axes of movement of the two adjacent release elements are substantially in the same line.
